(19) United States
(12) Patent Application Publication
(10) Pub. No.: US 2019/0069169 A1
(43) Pub. Date: Feb. 28, 2019

(54) WIRELESS COMPUTING NETWORK

(71) Applicant: Jean-Claude Louis Detre, Oviedo, FL (US)

(72) Inventor: Jean-Claude Louis Detre, Oviedo, FL (US)

(21) Appl. No.: 15/992,414

(22) Filed: May 30, 2018

Related U.S. Application Data
(60) Provisional application No. 62/551,310, filed on Aug. 29, 2017.

(51) Int. Cl. H04W 12/06; H04L 29/06

(52) U.S. Cl. CPC H04W 12/06; H04W 84/12; H04L 63/0209; H04L 63/083

(57) ABSTRACT

A universal wireless computing system is provided. The wireless computing system includes two or more devices having a systemic software application loaded thereon. A host device rebroadcasting a third-party wireless signal so that similarly situated devices also having the systemic software application can access and a rebroadcast the wireless signal for other proximate similarly-situated devices to access and rebroadcast.

### CROSS-REFERENCE TO RELATED APPLICATION

This application claims the benefit of priority of U.S. provisional application No. 62/551,310, filed 29 Aug. 2017, the contents of which are herein incorporated, by reference.

### BACKGROUND OF THE INVENTION

The present invention relates to wireless communication systems and, more particularly, a universal wireless network system providing permission to a shared wireless signal broadcasted to similarly situated device 14s, wherein each device has software of the present invention loaded thereon, and as long as one of the devices is connected to a wireless communication (“WC”) network of said wireless signal.

For those on the go who need to stay connected outside their mobile network, but do not want to use their data plan, yet want the speed of a WC network, it's a requirement to identify a WC provider and have the requisite password for each provider because password protection is the controlling mechanism of retaining a degree of WC security. Thus, such an individual may have to query dozens of potential WC networks within their ever-changing proximity to find one that is not password protected.

As can be seen, there is a need for something more than a data plan that one can share through turning their device into a hot spot. What is needed is a wireless network system embodying a software application configured to broadcast a wireless signal from a host device to other proximate software-loaded devices without providing access to personal information on the host device or the network they are connected to, thereby establishing a secure wireless network by enabling other software-loaded devices to connect through the host device in a secured manner, protecting the network.

In other words, if the host device can connect to a secured WC network by entering the security password, through a network access point or the like, other proximate software-loaded devices are automatically granted permission to connect only to the host WC signal, while not connecting to the mobile network, thereby bypassing the password login. Additionally, the present invention embodies a restrictive firewall that separates the host device's personal data and WC router. If any intrusions are detected the connection with the requester will be atomically denied and stored for preventing future intrusions by the software application loaded on the host device.

### SUMMARY OF THE INVENTION

In one aspect of the present invention, a method of enabling network access in a password-based wireless networking environment includes the steps of: providing two or more devices, each device equipped with a software application providing a wireless communications capability for communicating in a systemic networking environment with devices equipped with said software application; receiving, from a network access point of said password-based wireless networking environment, a wireless communication signal of said password-based wireless network environment from a selected one of the two or more devices; and said selected one broadcasting said wireless communication signal.

In another aspect of the present invention, the method of enabling network access in a password-based wireless networking environment includes the steps of: providing two or more devices, each device equipped with a software application providing a wireless communications capability for communicating in a systemic networking environment with devices equipped with said software application; receiving, from a network access point of said password-based wireless networking environment, a wireless communication signal of said password-based wireless network environment from a host device of the two or more devices; said host device broadcasting said wireless communication signal; and the software application is configured to provide a security module to perform the following steps: preventing access, through the systemic networking environment, to information stored on a form of memory of the devices equipped with said software application blocking an intrusion to the software application and thereby said wireless communication signal; detecting an unblocked intrusion to the software application; and if said unblocked intrusion is detected, disabling said wireless communications capability of the respective device, whereby the systemic networking environment comprises the host device and the remaining devices of the two or more devices broadcasting and rebroadcasting said wireless communication signal, respectively, whereby each device has access through the network access point, and whereby each device acts as a firewall to the systemic networking environment.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention; and

FIG. 2 is a flow chart of an exemplary embodiment of the present invention.

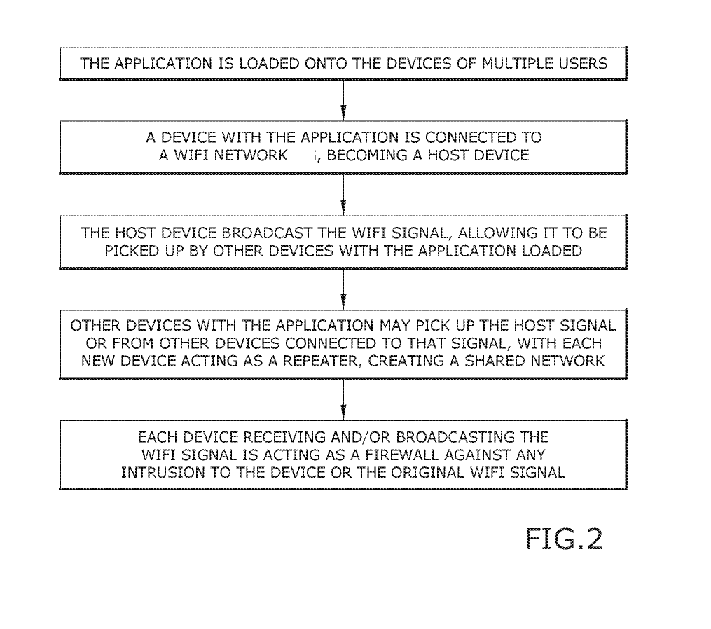

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a universal wireless system comprising a shared wireless signal broadcasted from a host device and only accessible by similarly situated devices, i.e., only devices having software of the present invention loaded thereon.

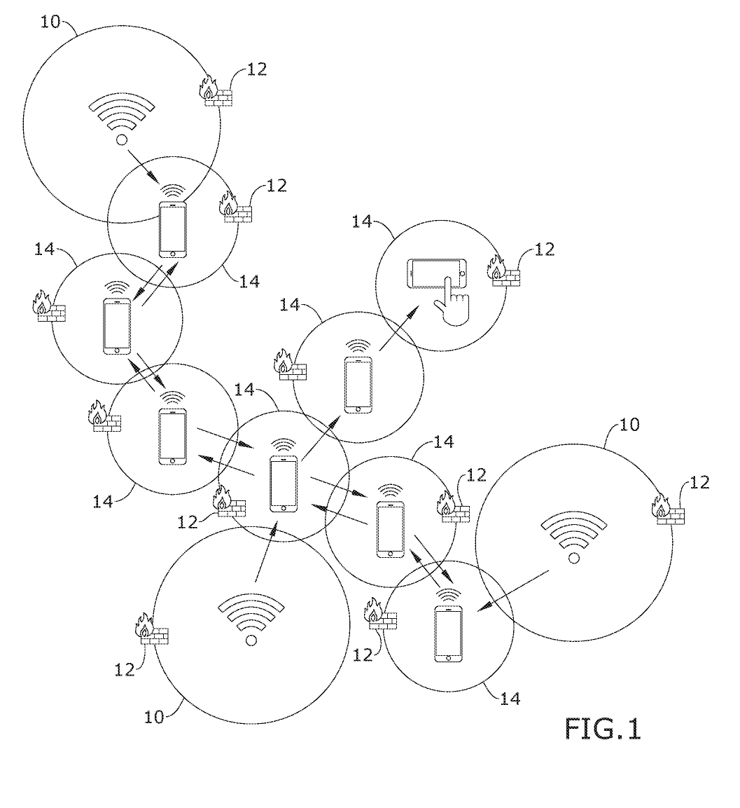

Referring now to FIG. 1, the present invention may include a wireless communication system providing universal wireless access to only similarly situated devices 14. The present invention may include at least one computing device 14 with a user interface. Each computing device 14 may include at least one processing unit coupled to a form of memory including, but not limited to, a server, a desktop, a laptop, or a smart device 14, such as, a tablet and smart phone. Each computing device 14 may include a program product including a machine-readable program code for causing, when executed, the computing device 14 to perform steps. The program product may include software which may either be loaded onto the computing device 14 or accessed by the computing device 14. The loaded software may include an application on a smart device 14. The software may be accessed by each computing device 14 using a web browser. Each computing device 14 may access the software via a web browser using the Internet, extranet, intranet, host server, internet cloud and the like.

A method of using the present invention may include the following. The software application disclosed above may be provided. Two or more devices 14 may be loaded with the software application, enabling each device 14 to be coupled to the universal sharing network. Each device 14, through the software application, is adapted to be a host device 14 configured to broadcast a WC signal 10 of a connected-to WC network that is available as long the host device 14 is signed in to said network. Another software-loaded device 14 within proximity may now rebroadcast the same WC signal 10 and repeating it for another similarly situated software-loaded device 14, thereby creating a network. If the WC signal 10 is dropped by a device 14, say because said device 14 left the range of the (re)broadcast WC signal 10, said device 14 may reach for the next available signal offered by a (more) proximate similarly situated device 14 (re)broadcasting the same or different WC signal 10, to be rebroadcast again by said device 14. Only subscribers of the software application are allowed on this universal network and are sharing connections with each other.

The present invention may change the way we connect to WC signal 10s when we are avoiding mobile data connections, facilitating computing networks where previously a computing device 14 was not allowed an Internet connection by restriction. The software application of the present invention could be part of a phone system at the time it leaves the factory and become a universal WC connection giving WC access to similarly situated devices 14. Security modules may be configured to block any intrusion to the transmitter application and to the original WC signal 10. If any intrusion is performed or detected, the software application may shut down the user and remove their access to any generated network. In other words, the security module enables the sharing of only the access to the WC signal 10, without giving access to personal data associated with the underlying computing device 14. Furthermore, the present invention embodies a restrictive firewall 12 that separates the host device's 14 personal data and WC router

Additionally, cars, machines, or any devices 14 representing the “Internet of Things,” where ordinary physical objects are seamlessly integrated into the information network may connect among each other through the present invention, creating a network on their own. Also, the present invention can create a universal network to share emergency notifications, relay imminent danger alters, or updates to a predetermined situation or occurrence.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the present invention.

What is claimed is:

1. A method of enabling network access in a password-based wireless networking environment, comprising the steps of:
providing two or more devices, each device equipped with a software application providing a wireless communications capability for communicating in a systemic networking environment with devices equipped with said software application;
receiving, from a network access point of said password-based wireless networking environment, a wireless communication signal of said password-based wireless network environment from a selected one of the two or more devices; and
said selected one broadcasting said wireless communication signal.

2. The method of claim 1, wherein said selected one is a host device of the two or more devices.

3. The method of claim 2, wherein the host device initially validated a password for accessing said password-based wireless network environment.

4. The method of claim 1, wherein the software application is configured to provide a security module to perform the following steps:
blocking an intrusion to the software application and thereby said wireless communication signal;
detecting an unblocked intrusion to the software application; and
if said unblocked intrusion is detected, disabling said wireless communications capability of the respective device,
whereby each device acts as a firewall to the systemic networking environment.

5. The method of claim 1, wherein the software application is configured to prevent access, through the systemic networking environment, to information stored on a form of memory of the devices equipped with said software application.

6. The method of claim 2, wherein the systemic networking environment comprises the host device and the remaining devices of the two or more devices broadcasting and rebroadcasting said wireless communication signal, respectively, whereby each device has access through the network access point.

7. A method of enabling network access in a password-based wireless networking environment, comprising the steps of:
providing two or more devices, each device equipped with a software application providing a wireless communications capability for communicating in a systemic networking environment with devices equipped with said software application;
receiving, from a network access point of said password-based wireless networking environment, a wireless communication signal of said password-based wireless network environment from a host device of the two or more devices;
said host device broadcasting said wireless communication signal; and
the software application is configured to provide a security module to perform the following steps:
preventing access, through the systemic networking environment, to information stored on a form of memory of the devices equipped with said software application blocking an intrusion to the software application and thereby said wireless communication signal;
detecting an unblocked intrusion to the software application; and
if said unblocked intrusion is detected, disabling said wireless communications capability of the respective device,
whereby the systemic networking environment comprises the host device and the remaining devices of the two or more devices broadcasting and rebroadcasting said wireless communication signal, respectively, whereby each device has access through the network access point, and
whereby each device acts as a firewall to the systemic networking environment.
